(19) United States
(12) Patent Application Publication
(10) Pub. No.: US 2007/0201482 A1
(43) Pub. Date: Aug. 30, 2007

(54) Automatic Scheduling of Activities between Multiple Participants

(76) Inventors: Akshar Kharebov, Goleta, CA (US); Sergey Lossev, Goleta, CA (US); Andrew Timothy Rogan, Saratoga, CA (US)

Correspondence Address: Hahn and Moodley LLP, P.O. Box 52050, Minneapolis, MN, 55402, US

(21) Appl. No.: 11/613,956

(22) Filed: Dec. 20, 2006

Related U.S. Application Data
(60) Provisional application No. 60/752,734, filed on Dec. 20, 2005.

(51) Int. Cl. H04L 12/56

(52) U.S. Cl. 370/395.2

(57) ABSTRACT

In one embodiment, the invention provides method, comprising: aggregating scheduling information for members of a social community to define aggregated scheduling information; discovering matches in the aggregated scheduling information; and notifying members of the social community of the matches.

This application claims the benefit of priority to U.S. Provisional Patent Application No., 60/752,734 which was filed on Dec. 20, 2005 and is entitled AUTOMATIC SCHEDULING OF ACTIVITIES BETWEEN MULTIPLE PARTICIPANTS.

### FIELD

Embodiments of the invention relate to scheduling activities between multiple participants,

### BACKGROUND

The Inventors have found that scheduling an activity between multiple participants (hereinafter referred to as “group scheduling”) can be a difficult task. For example, in order to schedule an activity such as a basketball game between a group of friends requires one person (“the organizer”) in the group to call each of the other persons in the group to inform the person of the game and to confirm the person's participation. Naturally, the viability of the game at the scheduled time is contingent upon each participant's availability and willingness to play at the scheduled time. Often, the participants have to be called or contacted several times as the organizer tries to change the day and time of the game to obtain everyone's participation,

### BRIEF DESCRIPTION OF THE DRAWINGS

The present invention will be understood and appreciated more fully from the following detailed description, taken in conjunction with the drawings in which:

FIG. 1 shows an online community including members for whom a group scheduling technique in accordance with one embodiment of the invention may be performed;

FIG. 2 shows a high-level block diagram of a scheduling server in accordance with one embodiment of the invention;

FIG. 3 shows a flowchart of operations performed by the scheduling server of FIG. 2, in accordance with one embodiment of the invention;

FIG. 4 shows a high-level block diagram of a client device in accordance with one embodiment of the invention; and

FIG. 5 shows an example of hardware that may be used to implement the scheduling server or the client device of FIGS. 2 and 4, respectively.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown at block diagram form only in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Advantageously embodiments of the present invention disclose techniques to automatically schedule an activity between multiple participants so that the above-described problems associated with group scheduling are at least reduced.

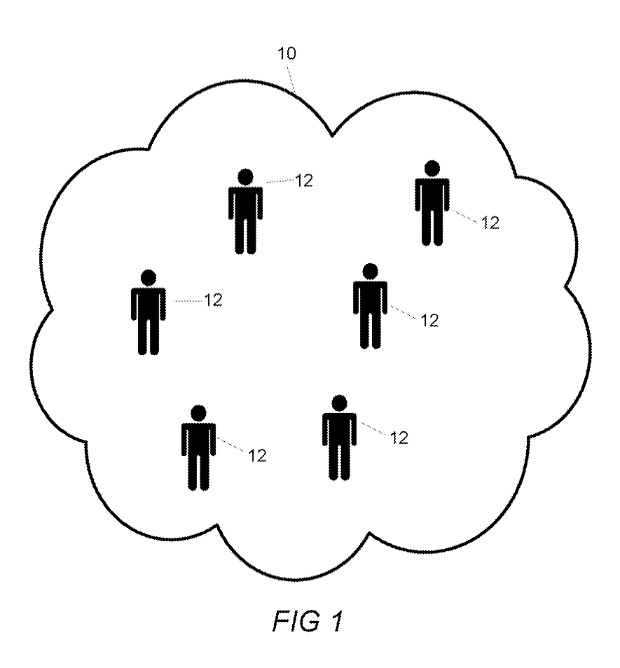

In one embodiment group scheduling is performed for a group of participants that define a virtual or online community, for example the online community 10 shown in FIG. 1 of the drawings.

Referring to FIG. 1 the online community 10 includes a number of members 12 who are able to communicate with each other via a communications fabric 14. The communications fabric 14 defines a communications medium and a communications protocol by which the members can communicate. In accordance with different embodiments of the invention the communications medium may be a wired medium or it may be a wireless medium. For example, the communications fabric may be the internet in which case the fabric is defined by the hypertext transfer protocol (HTTP) over the Transmission Control Protocol/Internet Protocol (TCP/IP). In other examples, the communications fabric may be defined by a General Packet Radio Service (GPRS) network a Code Division Multiple Access (COMA) network, the Institute of Electrical and Electronics Engineers (IEEE) wireless standard known as 802.11 network, or Structured Query Language (SQL)/Ethernet, etc.

In one embodiment, the online community may be a social community defined to facilitate social interaction between its members 12. Examples of such social communities include the online community known as Friendster, MySpace, Facebook, etc.

Each member 12 of the online community 10 has a member profile comprising profile information. Generally the profile information is used to facilitate interaction between the members of the online community 10, and in accordance with different embodiments of the invention may include such information as a member's name, sex, age, picture, interests, contact information, birthday, etc. In one embodiment, a member's profile also includes a friends/buddy list and sources of scheduling information (hereinafter “sources”). Based on the sources specified in a member's profile, a scheduling server that implements a group scheduling technique in accordance with one embodiment of the invention (as will be described later), aggregates scheduling information. Examples of sources include online social profiles, e.g. stored in MySpace, FaceBook, etc., an on-phone buddy list, a chat buddy list (e.g. America Online Instant Messaging, ICQ, Microsoft Network IM, Google Talk. Yahoo IM, etc.), a presence and location server, and a member's personal calendar. In general, a source specifies a location of scheduling information, and access or login information in order to gain access to the location. In one embodiment, the scheduling information may include a member's personal calendar, and availability.

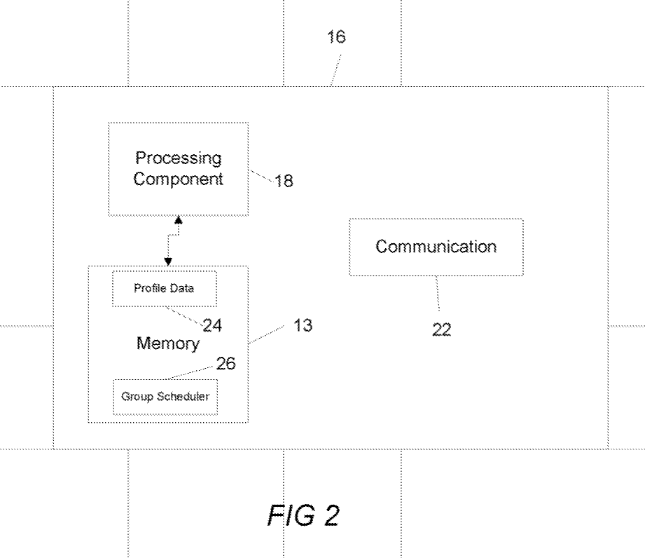

Referring now to FIG. 2 of the drawings, there is shown a server 16 that may be communicatively coupled to each of the members 12 of the online community 14. More accurately, the server 16 can be communicatively coupled to a client device used by a member 12 to communicate with other members 12 via the communications fabric 14

As can be seen from FIG. 2 of the drawings, the server 16 includes a processing component 18 which is coupled to a memory 20. The server 16 also includes a communications component 22 to facilitate communications with the members 12. Such communications may be in accordance with the communications mediums and protocols supported by the communications fabric 14. The memory 20 includes profile data 24 corresponding to the above-described member profiles. The memory 20 also includes a group scheduler 26, in accordance with one embodiment of the invention. Although the group scheduler 26 is described as implemented in software, in accordance with other embodiments of the invention the group scheduler 26, or at least some components thereof may be implemented in hardware. In other words, the description of the group scheduler 26 as a software component is intended to be merely illustrative, and therefore non-limiting.

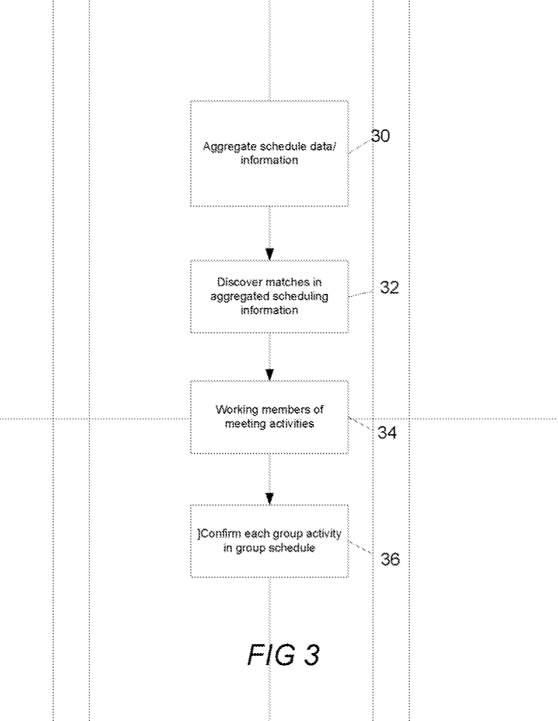

Referring now to FIG. 3 of the drawings, there is shown a flowchart of operations performed by the group scheduler 26, in accordance with one embodiment of the invention. As will be seen, at block 30, the group scheduler 26 aggregates schedule data/information for the various members 12 of the online community 14. In one embodiment, the particular operations performed at block 30 may be performed using an active procedure, or a passive procedure. For the active procedure, the group scheduler 26 actively establishes communications with the sources for each member 12, and retrieves scheduling information for that member, from each source. The active procedure may be performed on a periodic basis. In accordance with the passive procedure, a client device for each member 12 of the online community 14, establishes a communications session with the server 16, and pushes or sends scheduling information from the various sources to the group scheduler 26. For the passive procedure, the aggregation of the scheduling information from the various sources may be performed by the client device for a member 12.

Referring again to FIG. 3 of the drawings, at block 32 the group scheduler 26 discovers matches in the aggregated scheduling information. At block 34, the group scheduler 26 notifies the members 12 of the matching activities, and at block 36, the group scheduler 26 confirms each group activity in the group schedule based on input from the members 12.

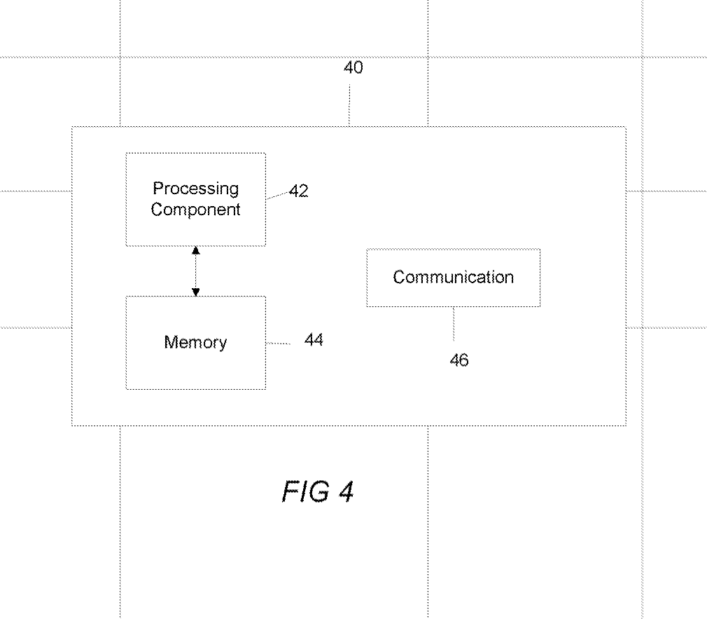

As described above, each member 12 interacts with the online community 14 via a client device which may be a mobile phone, a personal digital assistant (PDA), Pocket PC, etc. An example of such a client device is shown in FIG. 4 of the drawings, where it is indicated generally by reference numeral 40. Referring to FIG. 4, it will be seen that the client device 40 includes a processing component 42 which is coupled to a memory 44. The client device 40 also includes a communications component 46 to facilitate communications with other client devices within the online community 14. In one embodiment, the memory 44 may include a personal scheduling program which includes functionality to allow a member 12 to enter an activity, and to selectively upload that activity to the scheduling server 16.

In one embodiment, the scheduling program may be configured to automatically upload the activity to the scheduling server 16, whereas in another embodiments the scheduling program may be configured to only upload the scheduled activity if a member 12 indicates that the activity is to be uploaded. For example, in one embodiment the scheduling program may include an “upload button” which a member 12 selects in order to cause the scheduling program to upload the scheduled activity to the scheduling server 16. Entering an activity into the scheduling program, as described may include entering activity attributes such as activity type, activity location, and activity time.

In some embodiments, a member's personal schedule may not be stored locally within the client device 40, but may instead be stored on a server that is accessible by the client device 40.

In order to perform the operations at block 32, described with reference to FIG. 3 of the drawings, in one embodiment the group scheduler 26 may include a search engine. The search engine may be configured to search the schedules of all members 12 of the online community 14 to find or discover matching activities. In other embodiments, the search engine may be configured to search only the schedules of the members 12 who are included in the friends/buddy list of a particular member 12 who is an organizer of an activity. In yet a further case, the search engine may be configured to search the schedules of those members who are included in a custom activity partner list that the organizer defines on an ad-hoc basis, or the group scheduler 26 defines based on a history of previously scheduled activities. For example, the custom activity partner list may include sublists from the friends/buddy list for particular activities such as chess, basketball, movies, etc. Thus, for example if the organizer wishes to schedule a basketball game, the organizer simply inputs the location and time of the basketball game, and uploads this information to the scheduling server 16. The scheduling server 16, more particularly, the group scheduler 26 of the scheduling server 16, recognizes that the organizer (based on the organizer's profile), has a custom activity partner list for baseball, and thus only searches the schedules of those activity partners to find a match. In the case of an activity partner list based on history, the group scheduler 26 identifies those members 12 of the online community 14 with whom the organizer has played a basketball game in the past, and then searches the schedules of those members in order to find a match.

The search engine may be set to use different search/match criteria to identify matching activities. In one embodiment, the search criteria may be given different weights. For example, in one embodiment activity location is weighted more than activity time, and activity type is weighted more than activity place. Further, the search criteria may be set to find only exact matches. For example, if an organizer enters golf in his/her schedule, then no match will be found in the case of another friend/buddy from the online community 14 having the activity “sport” indicated in his/her schedule. In some embodiments, the organizer may set the search engine to search based on an “inexact match.” For this embodiment, if the organizers schedule indicates golf as an activity at a specified time and location, the search engine will match the activity “golf” with the activity “sport” discovered on the schedules of other members of the online community 14.

After the operations performed at block 32, the group scheduler 26 has a group schedule which comprises the activity type, place, and location of the matched activities for the entire community 14 or for a selected subset of that community.

The particular operations performed at block 34, described with reference to FIG. 3 of the drawings, includes, in one embodiment publishing the group schedule. Publishing the group schedule may include sending the group schedule to each of the members 12 of the online community 14 or to a limited subset of the members 12 of the online communities 14, as the case may be. In some cases, an invitation may be sent to a member 12, whereby the member 12 is invited to participate in a matched activity.

The operation of sending the invitation may be performed in the case of “implicit” scheduling, as opposed to “explicit” scheduling. Explicit scheduling refers to the case where a member 12 has scheduled an activity at a particular time which the group scheduler 26 attempts to match, in accordance with the above-described technique. In contrast, implicit scheduling refers to the case where a member 12 has no activity scheduled at a time for which a match is sought by the group scheduler 26. Thus, in the case of implicit scheduling, it is appropriate to send an invitation to the member who has been implicitly scheduled in order invite that member to participate in the matched activity.

In one embodiment, when a member 12 receives notification of the matched schedule, the member can confirm participation by sending a confirmation notification to the server 16. The server 16 then confirms that member's participation at block 36 by sending, for example, a confirmation notification to the member. In some cases, where the number of members that can participate in a particular activity is limited to a finite number, then once that particular finite number of members have confirmed the participation, the group scheduler 26 sends out a notification to the members of the online community 14 to indicate that that particular matching activity is now closed to further participation.

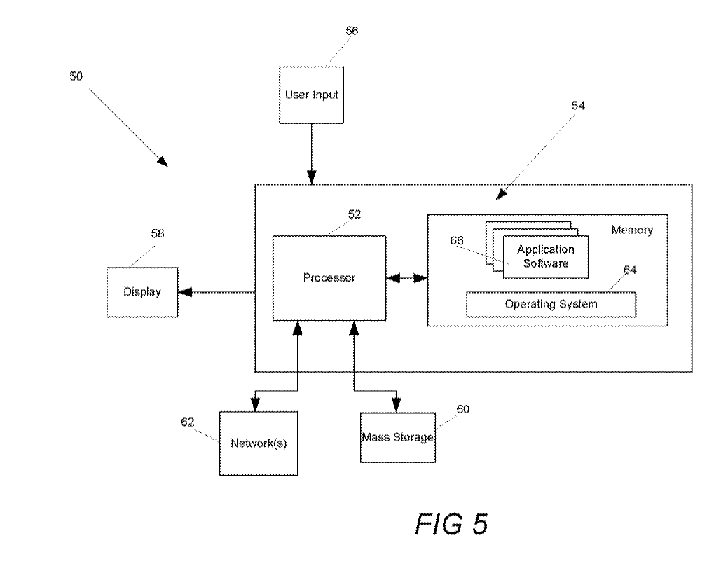

Referring to FIG. 5 of the drawings, shows an example of hardware 50 that may be used to implement the server 16 or the client device 40, in accordance with one embodiment of the invention. The hardware 50 typically includes at least one processor 52 coupled to a memory 54. The processor 52 may represent one or more processors (e.g., microprocessors), and the memory 54 may represent random access memory (RAM) devices comprising a main storage of the hardware 50, as well as any supplemental levels of memory e.g., cache memories, non-volatile or backup memories (e.g. programmable or flash memories), read-only memories, etc. In addition, the memory 54 may be considered to include memory storage physically located elsewhere in the hardware 50, e.g. any cache memory in the processor 52, as well as any storage capacity used as a virtual memory, e.g., as stored on a mass storage device 60.

The hardware 50 also typically receives a number of inputs and outputs for communicating information externally. For interface with a user or operator, the hardware 50 may include one or more user input devices 56 (e.g., a keyboard, a mouse, etc.) and a display 58 (e.g., a Cathode Ray lube (CRT) monitor, a Liquid Crystal Display (LCD) panel).

For additional storage, the hardware 50 may also include one or more mass storage devices 60, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 50 may include an interface with one or more networks 52 (e.g., a local area network (LAN), a wide area network (WAN), a wireless network, and/or the Internet among others) to permit the communication of information with other computers coupled to the networks. It should be appreciated that the hardware 50 typically includes suitable analog and/or digital interfaces between the processor 52 and each of the components 54, 56, 58 and 62 as is well known in the art.

The hardware 50 operates under the control of an operating system 64, and executes various computer software applications 66, components, programs, objects, modules, etc. (e.g. a program or module which performs operations described above) to perform other operations described with reference to FIGS. 1 through 4. Moreover, various applications, components, programs, objects, etc. may also execute on one or more processors in another computer coupled to the hardware 50 via a network 62, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

1. A method comprising:
aggregating scheduling information for members of a social community to define aggregated scheduling information;
discovering matches in the aggregated scheduling information, and
notifying members of the social community of the matches.
